(19) United States
(12) Patent Application Publication
(10) Pub. No.: US 2006/0282317 A1
(43) Pub. Date: Dec. 14, 2006

(54) METHODS AND APPARATUS FOR CONVERSATIONAL ADVERTISING

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, Pismo Beach, CA (US)

(21) Appl. No.: 11/278,369

(22) Filed: Mar. 31, 2006

Related U.S. Application Data
(60) Provisional application No. 60/689,301, filed on Jun. 10, 2005.

(51) Int. Cl. G06Q 30/00

(52) U.S. Cl. 705/14

(57) ABSTRACT

A method of rewarding conversational activity of a user maintaining a promotional conversation with an automated agent includes causing an automated agent to be presented to a user engaging a local computer, causing promotional information to be conveyed to the user in a promotional conversation via the automated agent, causing the automated agent to prompt the user for information in the promotional conversation, assessing the user's participation level in the promotional conversation, computing reward units based on the user's assessed participation level, and disbursing the computed reward units to a reward account associated with the user, wherein disbursed reward units are redeemable by the user for a reward.

This application claims the benefit of U.S. Provisional Application No. 60/689,301, filed Jun. 10, 2005, which is incorporated in its entirety herein by reference.

### BACKGROUND

1. Field of Invention

Embodiments described herein relate generally to the field of informational advertisements. More specifically, embodiments described herein relate to methods and apparatus for awarding rewards to users who interact with advertising content.

2. Discussion of the Related Art

In traditional media-content distribution models, content is provided to users free of charge in exchange for advertisements being embedded into the content stream. Traditional television content is distributed using this model, providing free video content to users in exchange for advertisements being embedded in the content stream as periodic commercials. Traditional radio content is also distributed using this model, providing free audio content to users in exchange for advertisements being embedded into the content stream as periodic commercials. Web page content is also distributed using this model, web content and services being provided free to users in exchange for advertisements being embedded into the displayed web page that provides the content or services. The benefit of such traditional media distribution models is that sponsors pay for the distribution of content to users, giving users free access to desirable content. Sponsors do this because the users are being exposed to the sponsors advertising messages as they view the content.

A significant problem with the traditional media-content distribution model is that the sponsors have no guarantee that the user is actually exposed to the advertising message that has paid for the accessed content. For example, in traditional television programming, a viewer may change the channel, leave the room, mute the television, engage in a side conversation, or simply not pay attention when a paid commercial is being displayed. With the advent of recordable mediums for television, like TiVo for example, the viewer may be watching a recording of the content and may simply fast-forward past some or all of the advertisements. With the advent of more intelligent recordable mediums for television, the user may even use a smart processing system that automatically forwards past some or all of the advertisements. Similar problems exist for radio. In traditional radio programming a viewer may change the channel, leave the room, mute the radio, engage in a side conversation, or simply not pay attention when a paid commercial is being displayed by the radio player. With the advent of recordable mediums for radio, including but not limited to downloadable podcasts of radio content, the listener may be listening a recording of the content and may simply fast-forward past some or all of the advertisements. With the advent of more intelligent recordable mediums for radio broadcasts, the user may even use a smart processing system that automatically forwards past some or all of the advertisements. Similar problems exist for web-based advertisements. In traditional web advertising methods, a user is exposed to displayed advertisements on the same web page, using around the borders of the page, on which the desired content or services is being displayed. The user may simply ignore such simultaneously displayed advertisements, may not have their window open all the way to even display the advertisements, or may filter out advertisements intelligent web page processing methods. The end result is that sponsors who pay for video programming such as television, audio programming such as radio, and web based content and services, often have little assurance that users are actually being exposed to the message they are providing in exchange for paying for the content.

Another problem with traditional media content distribution models is that media is now being distributed in new ways. With content-on-demand services and pointcast systems, content is no longer presented in a linear manner such that paid advertisements can be easily intermingled within the content stream. Some systems have been developed that do just that, but they suffer from all the traditional problems described above. The most common solution to the problem for content-on-demand services is to avoid paid advertisements altogether and shift to a pay-per-view model for users. Clearly a better solution is needed that retains the benefits of paid advertising but better meshes with the non-linear nature of content-on-demand and pointcast technologies.

To solve this problem, numerous systems have been developed. One such system tracks a user's eye gaze as he or she explores content on a web page and awards rewards to the user if and when his or her gaze corresponds with the location of certain advertisements. This method, as disclosed in U.S. Patent Application Publication No. 2005/0108092which is hereby incorporated by reference, does not fully solve the problem for eye gaze upon an area of a web page does not guarantee that a user is actually paying attention to the adverting content. Also such a system requires eye-tracking equipment, both hardware and software, and is subject to calibration errors and other complexities. Also, such a system is no use for radio and other audio-only advertising medium. Also, such a system is not useful for system wherein the advertising content is displayed at the same location, but at different times, from the primary content such as television commercials. All in all, such systems have limited value and there is substantial need for additional solutions to this problem.

Another system that has been developed to solve this problem is disclosed in U.S. Patent Application Publication No. 2005/0028190which is hereby incorporated by reference. This system requires the user to press an input button as part of the television advertising process. This is intended to ensure that the user watches the advertisement, but it does nothing to ensure that the user is actually paying attention or has not left the room right after the user has pressed the button. Furthermore, the user may be engaged in a side conversation or may be reading a book or doing some other distracting activity that reduces or eliminates the user's actual exposure to the information. All in all, such systems have limited value and there is substantial need for additional solutions to this problem.

Other systems have been developed to address this problem, particular those aspects of the problem created by on-demand-programming and pointcast systems. One such system is disclosed in U.S. Patent Application Publication No. 2001/0041053which is hereby incorporated by reference. The system provides credit to a user for viewing an advertisement, such as a commercial, the credit being usable to purchase on-demand-programming. Such a system does not provide a convenient, natural, or quantifiable means to determine if the user was actually exposed to the informational content of the advertisement and/or the level of exposure that was achieved. Thus, many of the same problems described above for traditional media-content distribution holds true for such on-demand-programming media content distribution models.

### SUMMARY

Several embodiments exemplarily described herein address the needs above as well as other needs by providing methods and apparatus for conversational advertising.

One embodiment exemplarily described herein provides a method of rewarding conversational activity of a user maintaining a promotional conversation with an automated agent that includes causing an automated agent to be presented to a user engaging a local computer, causing promotional information to be conveyed to the user via the automated agent in a promotional conversation, causing the automated agent to prompt the user for information during the promotional conversation, assessing the user's participation level in the promotional conversation, computing reward units based on the user's assessed participation level, and disbursing the computed reward units to a reward account associated with the user, wherein disbursed reward units are redeemable by the user for a reward.

Another embodiment exemplarily described herein provides an apparatus for rewarding conversational activity of a user maintaining a promotional conversation with an automated agent that includes a local computer containing circuitry adapted to: cause an automated agent to be presented to a user engaging the local computer, cause promotional information to be conveyed to the user via the automated agent in a promotional conversation, cause the automated agent to prompt the user for information in the promotional conversation, assess the user's participation level in the promotional conversation, compute reward units based on the user's assessed participation level, and disburse the computed reward units to a reward account associated with the user, wherein disbursed reward units are redeemable by the user for a reward.

Still another embodiment exemplarily disclosed herein describes an apparatus for rewarding conversational activity of a user maintaining a promotional conversation with an automated agent that includes means for causing an automated agent to be presented to a user engaging the local computer, means for causing promotional information to be conveyed to the user via the automated agent in a promotional conversation, means for causing the automated agent to prompt the user for information in the promotional conversation, means for assessing the user's participation level in the promotional conversation, means for computing reward units based on the user's assessed participation level, and means for disbursing the computed reward units to a reward account associated with the user, wherein disbursed reward units are redeemable by the user for a reward.

### BRIEF DESCRIPTION OF THE DRAWINGS

The above and other aspects and features of the several embodiments described herein will be more apparent from the following more particular description thereof, presented in conjunction with the following drawings.

FIG. 1 illustrates a written transcript of a sample dialogue between an automated agent (AA) and a user (USER) who are engaged in a promotional conversation using the methods and apparatus described herein;

FIG. 2 illustrates an exemplary rendering of an automated agent that is embodied as a character visually displayed to the user; and

FIG. 3 illustrates one embodiment of an exemplary conversational advertising apparatus.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of the various embodiments described herein. Also, common but well-understood elements that are useful or necessary in a commercially feasible embodiment are often not depicted in order to facilitate a less obstructed view of the various embodiments described herein.

### DETAILED DESCRIPTION

The following description is not to be taken in a limiting sense, but is made merely for the purpose of describing the general principles of exemplary embodiments. The scope of the invention should be determined with reference to the claims.

Generally, numerous embodiments described herein provide conversational advertising methods and apparatus for rewarding a user's conversational activity in maintaining a promotional conversation with an automated agent, wherein the automated agent conveys promotional information to the user from a local store of promotional information and/or from an internet-based store of promotional information, and wherein the reward is computed based on the conversational activity of the user.

As described herein the term “promotional conversation” is a conversation in which the automated agent at least verbally conveys promotional information to the user through a conversational dialog exchange that includes back and forth verbal participation of the automated agent and the user. Accordingly, a promotional conversation is also referred to herein as a conversational advertisement. In one embodiment, the automated agent may, in the promotional conversation visually convey promotional information (e.g., in the form of images, videos, and/or text documents) to the user. In such an embodiment, the automated agent may be visually conveyed to the user by the conversational advertising apparatus as showing, for example, a picture of the subject of the promotional information (e.g., a particular car) to the user during a promotional conversation related to the promotional information subject.

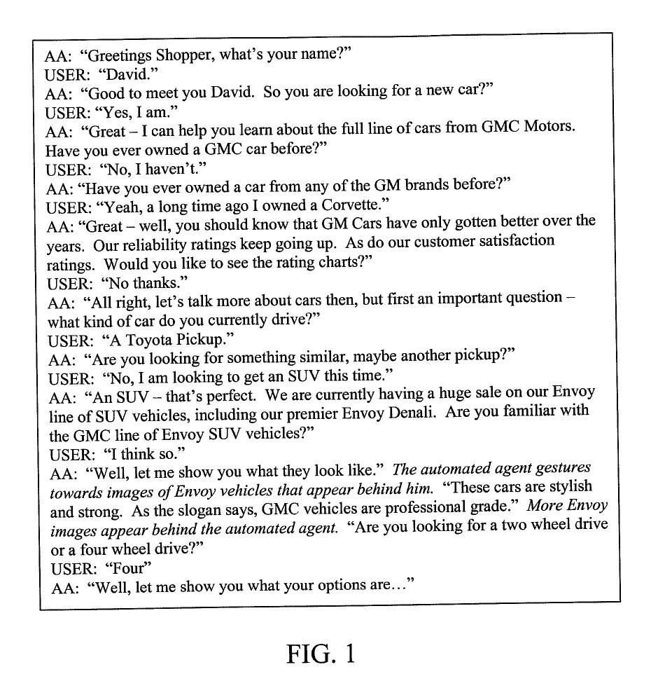

FIG. 1 illustrates a written transcript of a sample dialogue between an automated agent (AA) and a user (USER) who are engaged in a promotional conversation using the methods and apparatus described herein. In the illustrated embodiment, the promotional conversation includes the automated agent asking questions as a means of soliciting information from the user that will assist circuitry within the conversational advertising apparatus that generates the automated agent and/or determines information delivered by the automated agent to better tailor the promotional information to the desires, taste, background, or personal characteristics of the user. In this way, the promotional conversation is an effective way of presenting promotional information to a user in a natural, engaging, adaptable, and customizable format that adjusts information to a needs and/or tastes of a particular user. In one embodiment, the promotional conversation includes verbal interaction from the user and thereby ensures that the user is engaged in the conversation and is being sufficiently exposed to the desired promotional information.

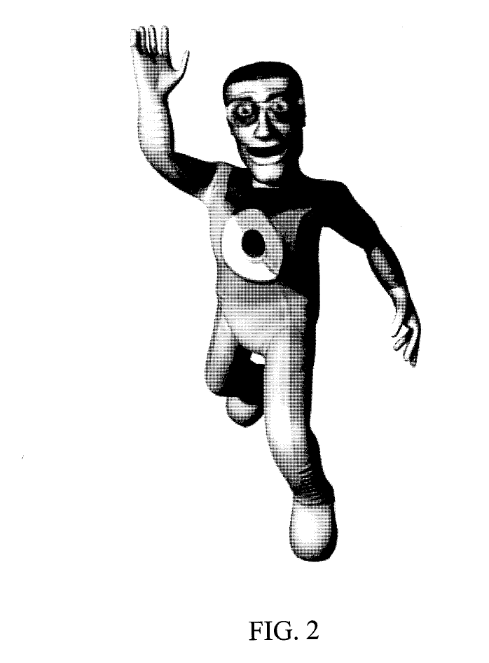

In one embodiment, a promotional conversation is entirely audible and the automated agent is presented to the user as only an audible, computer generated voice. In another embodiment, the promotional conversation is audible and visual and the automated agent can be presented to the user as a computer generated voice and a character visually displayed to the user. FIG. 2 illustrates an exemplary rendering of an automated agent that is embodied as a character visually displayed to the user. The automated agent exemplarily shown in FIG. 2 in comprised of a computer generated image that is manipulated under computer control and a computer generated voice that is produced under computer control. In one embodiment, the computer generated voice may be coordinated with graphical mouth motions, facial expressions, hand gestures, and eye movements.

In another embodiment, a promotional conversation is audible and visual in that the user can also engage with the automated agent via non-verbal interactions (e.g., gestures and expressions including, but not limited to, head nods, frowns, smiles, changes in posture, and eye activity), wherein the user's gestures and expressions are performed by image capture and processing techniques known to the art. Two exemplary methods and apparatus for image based gesture recognition of a user are disclosed in U.S. Patent Application Publication Nos. 2004/0190776and 2002/0181773, which are both hereby incorporated by reference. One exemplary method and apparatus for image based facial expression recognition is disclosed in U.S. Patent Application No. 2005/0102246, which is hereby incorporated by reference.

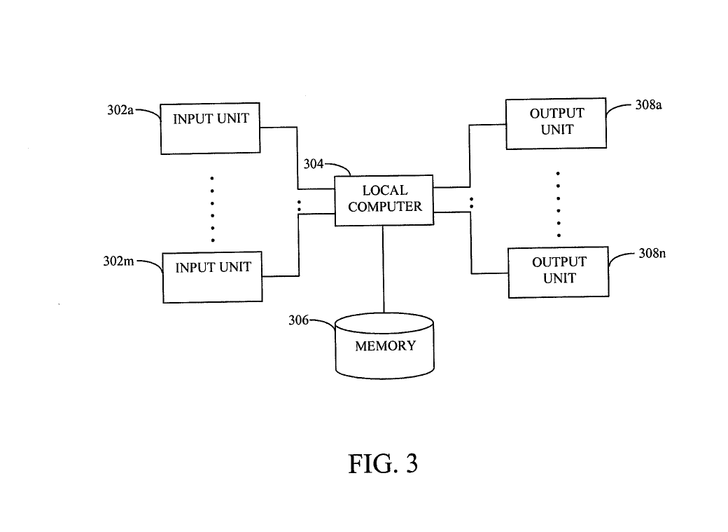

According to numerous embodiments exemplarily disclosed herein, a conversational advertising apparatus is adapted to provide a conversational interface through which a user can verbally interact with an automated agent to maintain a promotional conversation. The conversational advertising apparatus may further be adapted to reward the user based on his/her conversational activity with the automated agent. Accordingly, and in one exemplary embodiment shown in FIG. 3, the conversational advertising apparatus may include at least one input unit 302a to 302m, a local computer 304 coupled to the at least one input unit 302a to 302m, memory 306 adapted to store data in a manner that is accessible by the local computer 304, and at least one output unit 308a to 308n coupled to the local computer 304.

According to numerous embodiments, the local computer 304 is adapted to present an automated agent to a user via at least one output unit 308a to 308n, cause promotional information to be presented to the user via the automated agent in the form of a promotional conversation, and is further adapted to be engaged by the user (e.g., verbally, visually, etc.) via the at least one input unit 302a to 302m. Accordingly, the local computer 304 supports speech recognition circuitry adapted to discern and interpret the words and phrases captured by the at least one input unit 302a to 302m, conversation interface circuitry adapted to react to the words and phrases discerned and interpreted by the speech recognition circuitry by identifying promotional information stored within a store of promotional information stored within the memory 306 that is accessible to the local computer 304, speech synthesis circuitry adapted to produce a computer generated voice via at least one output unit 308a to 308n that verbally conveys the identified promotional information to the user, participation assessment circuitry adapted to assess the user's participation level in the promotional conversation based upon one or more measures of the user's conversational activity (i.e., one or more participation metrics), reward computation/disbursement circuitry adapted to compute reward units based on the user's assessed participation level and further adapted to disburse the computed reward units to the user, a sponsor of the advertisement, and/or a creator of advertisement, etc. Reward units disbursed to the user are redeemable for a reward (e.g., a predetermined amount of media content that is presentable to the user). In one embodiment, the local computer 304 may further contain character rendering circuitry adapted to produce a computer generated image via at least one output unit 308a to 308n that visually corresponds with the promotional information verbally conveyed to the user. As used herein, the term “circuitry” refers to any type of executable instructions that can be implemented, for example, as hardware, firmware, and/or software, which are all within the scope of the various teachings described.

In view of the general description of the conversational advertising apparatus above, an exemplary conversational advertising method may be employed to reward a user based on the his/her conversational activity with an automated agent. In one embodiment, such a conversational advertising method may, for example, include steps of presenting an automated agent to a user via at least one output unit 308a to 308n; causing promotional information to be conveyed to the user (e.g., verbally) via the automated agent; employing speech recognition circuitry to discern/interpret spoken words of a user captured by at least one input unit 302a to 302m; employing conversation interface circuitry to react to the spoken words of he user by identifying promotional information stored within a store of promotional information stored within the memory 306 that is accessible to the local computer 304; employing speech synthesis circuitry to produce a computer generated voice via at least one output unit 308a to 308n that verbally conveys the identified promotional information to the user; employing participation assessment circuitry to assess the user's participation level in the promotional conversation based upon one or more participation metrics; employing reward computation/ disbursement circuitry to compute reward units based on the user's assessed participation level and to disburse the computed reward units to the user, the sponsor of the advertisement, and/or the creator of advertisement, etc., wherein reward units disbursed to the user are redeemable for an amount media content that is presentable to the user. In one embodiment, a conversational advertising method may further include a step of employing character rendering circuitry to produce a computer generated image via at least one output 308a to 308n unit that visually corresponds with the promotional information verbally conveyed to the user.

Having generally described exemplary embodiments of conversational advertising methods and apparatus in general, a more detailed description of each component within the conversational advertising methods and apparatus will now be provided.

In one embodiment, at least one input unit 302a to 302m is adapted to capture words and phrases uttered by a user. In another embodiment, at least one input unit 302a to 302m is adapted to capture gestures and motions given by a user. Accordingly, each input unit 302a to 302m may, for example, include a microphone, a camera, a motion capture apparatus, a facial recognition apparatus, or the like, or combinations thereof.

In one embodiment, at least one output unit 308a to 308n is adapted to present the generated voice as audible sound to the user. In another embodiment, at least output unit 308a to 308n is adapted to present the generated image as visible light to the user. Accordingly, each output unit 308a to 308n may, for example, include a speaker, headphones, a monitor, a cell phone, or other audio/video generating hardware.

The local computer 304 may be a dedicated computer such as a typical household PC or the local computer 304 may be a processor-driven television system such as a set-top box, a processor-driven communication device such as a cell phone, a processor-driven handheld device such as a portable media player, a PDA, a handheld gaming system, or the like. Accordingly, the local computer 304 can be any processor-driven device adapted to present conversational advertisements to a user. In one embodiment, the local computer 304 may be comprised of multiple computers working in coordination, each performing a portion of the required functions. In another embodiment, only one of the multiple computers working in coordination need actually be local to the user.

The memory 306 may be local to the local computer 304 or may be accessible by the local computer 304 over a network link. In one embodiment, the store of promotional information may include a text representation of the promotional information and/or may include an alternate symbolic representation of the promotional information.

In another embodiment, the store of promotional information may also include one or more demographic tags. As used herein, a demographic tag is a set of identifiers, links, and/or other symbolic associations that associate a piece of promotional information with demographic parameters that may describe a user. For example, a demographic tag may include a gender, age or age range, income level or income level range, political affiliation, highest level of education, geographic locations of residence, urban versus rural residence, language skill level, intelligence level, known medical conditions, known dietary habits or preferences, known music preferences, known color preferences, known accent preferences, temperament characterizations, and/or personality types. Such demographic tags are used to associate and/or weight certain stored pieces of promotional information with certain types of users and/or user characteristics. In this way, a user with certain characteristics can be provided with promotional information that is well tailored to that particular user as expressed conversationally by the automated agent.

In another embodiment, the store of promotional information may also include a demographic profile that describes the user of the local computer 304. The demographic profile may include, but is not limited to, the gender, age, income level, political affiliation, highest level of education, geographic location of residence, urban versus rural residence, language skill level, intelligence level, known medical conditions, known dietary habits or preferences, known clothing style preferences, known color preferences, known music preferences, known accent and/or accent preferences, temperament characteristics, and/or personality type for that user. In some embodiments, multiple demographic profiles are stored for multiple individuals who use the local computer 304. In one embodiment, the demographic profiles are entered by the user through a user interface. In one embodiment, the demographic profiles are automatically updated based upon the user's behavior during promotional conversations. For example, a user may be questioned during a promotional conversation with an automated agent about his or her car style preferences. That information may be added to the user's demographic profile for use in future promotional conversations. Similarly, circuitry supported by the local computer 304 may determine whether a user spends more time engaging a simulated character if that character looks a certain way, has a certain accent, speaks with a particular style or tone, or uses a particular conversing strategy. If and when such assessments are made, that certain character look, certain character vocal accent, certain vocal style or tone, certain conversing strategy may be documented in the user's demographic profile as being effective in engaging the user and therefore may be used with higher frequency in future conversations.

In another embodiment, the store of promotional information includes a scripted dialog to be verbally conveyed to the user by the automated agent. In one embodiment, the scripted dialog includes multiple dialog segments for conveying the same basic content, each of the multiple dialog segments being associated with different demographic tags. In this way, the system can select different dialog segments based upon the demographic characteristics of the particular user being engaged in the conversation. For example, the store of promotional information may include scripted dialog for promoting the benefits of a particular model of car, multiple sets of the scripted dialog being included, each of the sets being associated with different demographic tags. One set of dialog segments may have a scripted style that is particularly well suited for 18 to 25 year old males; another set of scripted dialog segments may have a scripted style that is particularly well suited to 18 to 25 year old females, another set of scripted dialog segments may have a scripted style that is particularly well suited to 26 to 35 year old males; etc. In addition to age and gender, other demographic factors may be associated with dialog segments of varying style, tone, and phrasing in the store of promotional information. For example, a user known to live in Florida may be presented with promotional dialog about the particular model of car that stresses the air-conditioning features of the car while a user known to live in Canada may be presented with promotional dialog about the particular model of car that stresses the handling of the car in snow. These customizations of the dialog segments are achieved in some embodiments, based in whole or in part upon the associations of the dialog segments with the demographic tags. It should be noted that some information and/or scripted dialog stored with the store of promotional information may be associated with multiple sets of demographic information. Also, it should be noted that some information and/or scripted dialog stored within the store of promotional information be associated with all users. For example, some dialog about the particular model of car in the example above, may be presented the same way to all users. Also, it should be noted that, in some embodiments, some information stored within the store of promotional information includes information that affects the voice quality, accent, and/or vocal speed of the automated agent and in some embodiments, associates the voice quality, accent, and/or vocal speed with demographic tags. In this way, a user whose demographic profile indicates that he is an elderly male user who is from rural Texas may be presented the promotional information through a conversation with an automated agent that speaks with a male voice and Texas accent and slow speed. On the other hand, a young female user from urban New York may be presented the promotional information through a conversation with an automated agent that speaks with a female voice and a New York accent and fast speed. Also, the young female may be presented with scripted dialog that includes slang words or phraseology that is appropriate for her age demographic and urban demographic while the elderly man from Texas is presented with scripted dialog that includes rural sayings and phraseology that is appropriate for his age demographic and rural demographic.

In another embodiment, the store of promotional information includes information other than scripted dialog and/or other conversation-related content. For example, the promotional information may include images, video clips, and text documents that may be displayed to the user during the conversation. For example, the user engaged in a promotional conversation with the automated agent about the particular model of car may be shown images of the car, video of the car, and/or text documents such as feature charts about the car during the promotional conversation. Multiple versions of the images, video clips, and/or text documents may be stored within the store of the promotional information, the multiple versions being associated with a variety of different demographic tags. The promotional information may also include information about the look, sound, gestures, and/or mannerisms of the automated agent that will be generated to enact the conversation. Multiple versions of the look, sound, gestures, and/or mannerisms of the automated agent may be stored within the store of the promotional information, the multiple versions being associated with a variety of different demographic tags. In this way, users with particular demographic characteristics may be exposed to images, video, and/or text that are tailored to their particular characteristics and/or preferences. For example, a user whose demographic profile documents a preference for the color red may be shown an image of the particular car model that depicts the car in red. Alternately, the user whose demographic profile documents a preference for the color red may be presented with a simulated character to converse with who is wearing a red shirt. Similarly, a user whose demographic profile documents a preference for engaging in promotional conversations with young women would be presented with an automated agent that looks and/or sounds like a young woman while a user whose demographic profile documents a preference for engaging in promotional conversations with older men would be presented with an automated agent that looks and/or sounds like an older man. In this way, both the content and the means of conveying the content are tailored for the characteristics and/or preferences of a particular user.

In another embodiment, the store of promotional information includes conditional information, the conditional information linking certain informational content and/or scripted dialog segments with particular conditional answers given by the user in response to particular questions asked by the automated agent. For example, the automated advertising agent may cause the simulated character to ask the user if he or she has purchased a new car within the last five years. If the answer given by the user is YES, a certain set of dialog segments may be given by the automated agent based upon the conditional information associated with that set of dialog segments in the store of promotional information. If the answer given by the user is NO, a different set of dialog segments may be given by the automated agent based upon the conditional information associated with that set of dialog segments in the store of promotional information. In this way, the automated agent can engage in a conversation that varies depending upon the responses given by the user to questions posed to the user.

In another embodiment, the store of promotional information includes information that answers common questions that might be asked by a user, the answers being linked or otherwise associated with tags that associate them to the common questions. In this way, the automated agent can address common questions posed to it by a user.

The aforementioned speech recognition circuitry may be provided in any manner known in the art. Substantial research and development has gone into the creation of automated speech recognition systems that capture a user's voice through a microphone, digitize the audio signal, process the digitized signal, and determine the words and phrases uttered by a user. One example of such a speech recognition system is disclosed in U.S. Pat. No. 6,804,643 which is hereby incorporated by reference. As disclosed in this patent, speech recognition systems consist of two main parts: a feature extraction (or front-end) stage and a pattern matching (or back-end) stage. The front-end effectively extracts speech parameters (typically referred to as features) relevant for recognition of a speech signal. The back-end receives these features and performs the actual recognition. In addition to reducing the amount of redundancy of the speech signal, it is also very important for the front-end to mitigate the effect of environmental factors, such as noise and/or factors specific to the terminal and acoustic environment.

The task of the feature extraction front-end is to convert a real-time speech signal into a parametric representation in such a way that the most important information is extracted from the speech signal. The back-end is typically based on a Hidden Markov Model (HMM), a statistical model that adapts to speech in such a way that the probable words or phonemes are recognized from a set of parameters corresponding to distinct states of speech. The speech features provide these parameters.

It is possible to distribute the speech recognition operation so that the front-end and the back-end are separate from each other, for example the front-end may reside in a mobile telephone and the back-end may be elsewhere and connected to a mobile telephone network. Similarly the front end may be in a computer local to the user and the back-end may be elsewhere and connected by a network, for example by the internet, to the local computer 304. Naturally, speech features extracted by a front-end can be used in a device comprising both the front-end and the back-end. The objective is that the extracted feature vectors are robust to distortions caused by background noise, non-ideal equipment used to capture the speech signal and a communications channel if distributed speech recognition is used.

Speech recognition of a captured speech signal typically begins with analog-to-digital-conversion, pre-emphasis and segmentation of a time-domain electrical speech signal. Pre-emphasis emphasizes the amplitude of the speech signal at such frequencies in which the amplitude is usually smaller. Segmentation segments the signal into frames, each representing a short time period, usually 20 to 30 milliseconds. The frames are either temporally overlapping or non-overlapping. The speech features are generated using these frames, often in the form of Mel-Frequency Cepstral Coefficients (MFCCs).

MFCCs may provide good speech recognition accuracy in situations where there is little or no background noise, but performance drops significantly in the presence of only moderate levels of noise. Several techniques exist to improve the noise robustness of speech recognition front-ends that employ the MFCC approach. So-called cepstral domain parameter normalization (CN) is one of the most effective techniques known to date. Methods falling into this class attempt to normalize the extracted features in such a way that certain desirable statistical properties in the cepstral domain are achieved over the entire input utterance, for example zero mean, or zero mean and unity variance.

The aforementioned speech synthesis circuitry may be provided in any manner known in the art. Many prior art technologies exist for synthesizing audible spoken language signals from a computer interface based upon a text script or other symbolic representation of the language. For example U.S. Pat. No. 6,760,703, which is hereby incorporated by reference, discloses methods and apparatus for performing speech synthesis from a computer interface. As disclosed in this patent, a method of artificially generating a speech signal from a text representation is called “text-to-speech synthesis.” The text-to-speech synthesis is generally carried out in three stages comprising a speech processor, a phoneme processor and a speech synthesis section. An input text is first subjected to morphological analysis and syntax analysis in the speech processor, and then to processing of accents and intonation in the phoneme processor. Through this processing, information such as a phoneme symbol string, a pitch and a phoneme duration is output. In the final stage, the speech synthesis section synthesizes a speech signal from information such as a phoneme symbol string, a pitch and phoneme duration. Thus, the speech synthesis method for use in the text-to-speech synthesis is required to speech-synthesize a given phoneme symbol string with a given prosody.

According to the operational principle of a speech synthesis apparatus for speech-synthesizing a given phoneme symbol string, basic characteristic parameter units (hereinafter referred to as “synthesis units”) such as CV, CVC and VCV (V=vowel; C=consonant) are stored in a storage and selectively read out. The read-out synthesis units are connected, with their pitches and phoneme durations being controlled, whereby a speech synthesis is performed. Accordingly, the stored synthesis units substantially determine the quality of the synthesized speech.

In the prior art, the synthesis units are prepared, based on the skill of persons. In most cases, synthesis units are sifted out from speech signals in a trial-and-error method, which requires a great deal of time and labor. Jpn. Pat. Appln. KOKAI Publication No. 64-78300(“SPEECH SYNTHESIS METHOD”) discloses a technique called “context-oriented clustering (COC)” as an example of a method of automatically and easily preparing synthesis units for use in speech synthesis.

The principle of COC will now be explained. Labels of the names of phonemes and phonetic contexts are attached to a number of speech segments. The speech segments with the labels are classified into a plurality of clusters relating to the phonetic contexts on the basis of the distance between the speech segments. The centroid of each cluster is used as a synthesis unit. The phonetic context refers to a combination of all factors constituting an environment of the speech segment. The factors are, for example, the name of phoneme of a speech segment, a preceding phoneme, a subsequent phoneme, a further subsequent phoneme, a pitch period, power, the presence/absence of stress, the position from an accent nucleus, the time from a breathing spell, the speed of speech, feeling, etc. The phoneme elements of each phoneme in an actual speech vary, depending on the phonetic context. Thus, if the synthesis unit of each of clusters relating to the phonetic context is stored, a natural speech can be synthesized in consideration of the influence of the phonetic context.

The aforementioned conversation interface circuitry may be provided in any manner known in the art. Some work has been done in the art to develop hardware and software methods that enable conversation between a computer generated character and a user. Such systems require various software components in addition to the speech recognition and speech synthesis components described above, including software components for discourse modeling and response planning. For example, U.S. Pat. No. 6,570,555, which is hereby incorporated by reference, describes a system that includes such components, disclosing a system in which a simulated character holds a conversation with a user as part of an instructional process that helps said user learn how to use a piece of equipment.

As disclosed within U.S. Pat. No. 6,570,555, a number of prior art systems have been developed that enable automated agents to be controlled by software. Such automated agents can be divided into two groups: those whose behaviors are scripted in advance, and those whose behaviors are autonomous as derived at runtime based on inputs from the user. The range of behaviors of the former type of character must be explicitly defined by the character's creator prior to the interaction with the user. One advantage of pre-scripting is that the integration of verbal and non-verbal behaviors need not be calculated at runtime which avoids processing burden. Scripted characters, on the other hand, are limited in their ability to interact with users and react to user inputs. Examples of scripted character systems include:

Document Avatars [Bickmore97] are characters are linked to hypertext documents, and can be scripted to perform specific behaviors when parts of the document are selected. Document avatars can be used to provide tours of a document. They can be scripted to speak, move around, point to objects and activate hyperlinks. Microsoft agent [Microsoft97] enables characters that can be scripted to speak text strings, perform one or more specific animated motions, hide, move and resize themselves. Jack Presenter [Badler97] describes a system allows an anthropomorphic 3D animated figure to be scripted to give a presentation to a user who passively observes. The character's author provides the narrative text which includes annotations describing coordinated motions and gestures for the character. PPP Persona [Andre96] is a project that uses a planning system to create tutorials of specified material. Presentations are not scripted by human authors, but are created by an automated planning system and users cannot interact with the characters during a presentation.

The second group of computer generated and controlled characters are the autonomous (or semi-autonomous) characters. Such work includes non-human characters such as those created by The MIT Media Laboratory's ALIVE system [Maes94], PF Magic's Dogz, Fujitsu Interactivel's Fin Fin, and CMU's Oz. Such work also includes systems for authoring anthropomorphic virtual actors such as the NYU Media Research Laboratory's Improv system [Perlin96]. Other work on automated agents includes the MS Office suite of applications which includes animated characters to provide user assistance and an interface to the online documentation. These characters can respond to typed, free-form questions, and respond with text balloons containing menu options. The Microsoft Persona project [Microsoft97] allows a user to control a computerized jukebox through an animated character that accepts speech input and produces spoken output with some gestures. Animated Conversation [Cassell94] is a system that includes two animated characters, Gilbert and George, who can converse with one another, using context-appropriate speech, gestures and facial expressions, to negotiate transactions. Ymni [Thorisson96] is an architecture for autonomous characters in which the user interacts with Gandalf, an animated character, using natural speech and gestures to ask questions about the solar system. Finally, recent research [Reeves&Nass97] has suggested that human interactions with computer generated media are intrinsically social in nature and that we unconsciously treat computers as social actors. Furthermore it suggests that the rules that govern our social interactions with other people are imputed by users to media content presented by their computers. This means that character based interfaces, especially those that are conversational in structure, are likely to be well accepted by users.

As disclosed in U.S. Pat. No. 6,570,555, which is incorporated herein by reference, a system has been developed that is effective at allowing a user to maintain a conversation with a simulated character, the conversation being enacted as vocal utterances on the part of the user and synthesized speech on behalf of the simulated character. In this computer generated system, characters and users communicate with the user through speech, facial expressions and gestures. The architecture provides a unified model that processes both content-bearing and interactional behaviors in both input and output modalities. The system provides an architecture for building animated interfaces with task-based, face-to-face conversational abilities (i.e., the ability to perceive and produce paraverbal behaviors to exchange both semantic and interactional behaviors. Characters developed under the architecture have the ability to perceive the user's speech, body position, certain classes of gestures, and general direction of gaze. In response, such characters can speak, make gestures and facial expressions, and direct their gaze appropriately. These characters provide an embodied interface, apparently separate from the underlying system, that the user can simply approach and interact with naturally to gather information or perform some task. Furthermore, the system includes methods to deals with content-bearing information (generating the content of a conversation in several modalities) and methods to deal with the nature of interactions between the two participants in a conversation, likewise relying on several modalities. The system also integrates and unifies reactive and deliberative architectures for modeling autonomous anthropomorphized characters who engage in face-to-face interactions. A reactive architecture gives a character the ability to react immediately to verbal and non-verbal cues without performing any deep linguistic analysis. Such cues allow the character to convincingly signal turn-taking and other regulatory behaviors non-verbally. A deliberative architecture, on the other hand, gives the characters the ability to plan complex dialogue, without the need to respond reactively to non-verbal inputs in real time. The system also merges reactive and deliberative functionalities, allowing a character to simultaneously plan dialogue while exhibiting appropriate reactive non-verbal behaviors. The integration of reactive and deliberative behaviors is accomplished in the architecture by a modular design centered around a component, the “reactive module,” that runs in a tight loop constantly evaluating the state of the “world” at each iteration. Information about the world comes from raw input data representing non-verbal behaviors, such as coordinates that specify where the human user is looking, as well as processed data from deliberative modules, such as representations of the meanings of the user's utterances or gestures. At each step, the reactive module makes decisions, based on weights and priorities (the salience of each of a set of rules whose preconditions have been satisfied), about which inputs require action and how the actions are to be organized. Deliberative behaviors are subject to regulation by the reactive module, so that, for example, the character knows it may need to ignore the user's speech if the user turns her back on the character. The reactive behaviors are the product not only of the immediately preceding actions, but also of dialogue plans (produced in by the deliberative language components) which may require several loop iterations to be executed. For example, the character's gaze behavior, which is a prominent indicator of turn-taking in dialogue, might be affected by its knowledge that several plan steps must be executed to achieve a particular discourse goal.

The above descriptions of conversation interface circuitry is given as enablement for the use of computer systems that enable user interaction through promotional conversation by providing one or more characters with a synthesized voice and by processing the vocal utterances of a user. As described above, such systems can include a fully animated graphical representation of the simulated character with simulated gestures and motions. Such systems can also include gesture tracking, eye tracking, and other non-verbal assessment of user expression and focus. While such systems can be rich in features, the invention disclosed herein need not use all of such features. Embodiments exemplarily described herein can comprise simple audio-only systems, in which the simulated character is displayed only as an audible voice and wherein user input is entirely vocal or more sophisticated embodiments that also display graphical representations of the simulated character and include non-verbal conversational content such as gestures and facial expressions.

As mentioned above, the participation assessment circuitry is adapted to assess the user's participation level in the promotional conversation based upon one or more participation metrics. Exemplary participation metrics include, but are not limited to, the time duration of the promotional conversation maintained by the user and the automated agent, the interest level expressed by the user during the promotional conversation with the automated agent, the forthcomingness of the user when asked questions by the automated agent during the promotional conversation, the amount/proportion of information conveyed to the user by the automated agent during the promotional conversation, the number of times information was conveyed to the user by the automated agent during the promotional conversation, the type, value, and/or importance of the information conveyed to the user by the automated agent during the promotional conversation, or any combination thereof.

In one embodiment, the time duration of the promotional conversation maintained by the user and the automated agent is assessed by accessing a running incremental timer or clock that determines the time interval from an initiation of the conversation to a conclusion of the conversation.

In another embodiment, the time duration of the promotional conversation maintained by the user and the automated agent is assessed by tallying an incremental time value only for periods when context assessment circuitry, supported by the conversational advertising apparatus, determines whether or not responses to a given question are context-appropriate and, therefore, whether the user's participation and/or focus is above a certain threshold limit. In such an embodiment, the context assessment circuitry is adapted to assess. User participation/focus may be determined based on the user verbally responding to questions posed to him or her by the automated agent. So long as the user is responding to questions, the responses coming in a timely manner and the questions are determined to be context-appropriate, the incremental timer value is tallied. For periods when the user fails to respond questions, fails to respond to questions in a timely manner, and/or responds to questions in a way that is determined not to be context-appropriate, the incremental timer value is not tallied and/or is tallied at a reduced rate. In this way, the user only increments his or her accrued time value at a maximum rate when participating at a sufficient level of interaction with the automated agent.

As used herein, a “context-appropriate” response to a question is a response that makes semantic or logical sense to the question posed. For example, if the user is asked what his favorite color car is and he responds verbally with “green”, the response is context-appropriate because the response makes semantic and/or logical sense. If, on the other hand, the user responds to the question with “yes”, this is not a context appropriate response because “yes” does not logically and/or semantically answer the question that was asked. In this way, the conversational advertising apparatus can determine if a user is actually paying attention to the promotional conversation or if the user is just answering —“yes” to all questions asked or uttering other words that are not reasonable responses.

In embodiments where user participation/focus is determined based, in whole or in part, upon whether or not the user's responses to questions posed by the automated agent are context-appropriate, the store of promotional information may include a listing of context appropriate responses and/or forms of responses to questions created for a given promotional advertisement. For example, a promotional advertisement for a particular car may be created such that the store of promotional information includes a listing of all possible questions to be asked by the automated agent to users. Also listed for some or all of the questions are a listing (or symbolic representation) of some or all likely context-appropriate responses. For example, a question listed within the store of promotional information for a car advertisement may be “Do you prefer two-wheel drive or four-wheel drive?” Also listed in the store of promotional information is a listing of the most likely context-appropriate responses such as “Two”, “Four”, “Two Wheel Drive”, “Four Wheel Drive”. Also included may be other acceptable context-appropriate words or phrases such as “Both” or “It does not matter to me” or “Which ever is cheaper” or “Which ever gets the best gas mileage”. In some cases, key words or phrases may also be listed that would indicate a likely context-appropriate response such as “gas mileage”, “off-roading” or “mountains” or “skiing” or “snow” or “mud” or “towing” or “safety”, etc.

As described in the embodiments above, the context assessment circuitry is adapted to determine whether the user's participation and/or focus is above a certain threshold limit based upon a determination of whether or not a user's responses to a given question are context-appropriate. In other embodiments, however, the context assessment circuitry may be adapted to determine whether the user's participation and/or focus is above a certain threshold limit based upon other determinations. For example, the context assessment circuitry may be adapted to determine whether the user's participation and/or focus is above a certain threshold limit based, in whole or in part, upon a user's eye movement, gestures, and/or facial expressions. Accordingly, the context assessment circuitry may include eye-tracking means, gesture evaluation means, and/or facial expression evaluation means (e.g., one or more cameras adapted to capture a digital image of the user's face, or body) and be further adapted to process the digital images to determine eye location, facial expressions, and/or gestures, using techniques known in the art. In such embodiments, the incremental time is tallied only when the eye-tracking motions, facial expressions, and/or gestures are determined by the context assessment circuitry to be context-appropriate. A context-appropriate eye motion, for example, is a user's eye motion towards an image being verbally referred to by the automated agent within a reasonable time frame of the verbal reference. A context-appropriate facial expression, for example, is a user's smile in response to a verbally conveyed joke uttered by the automated agent. A context-appropriate gesture is a user's affirmative or negative head-nod that is responsive to a question posed by the automated agent and is, for example within a reasonable time frame of the question posed.

In one embodiment, the interest level conveyed by the user during the promotional conversation is assessed by determining the number of questions asked by the user to the automated agent. In another embodiment, the interest level is assessed based upon the total number of words spoken by the user during the promotional conversation. In another embodiment, the interest level is assessed based upon the total number of context-appropriate words spoken by the user during the promotional conversation. In another embodiment, the interest level is further assessed in consideration of the user's facial expressions and gestures such as smiles, frowns, and head nods. For example, the interest level may be computed by tallying the number of context-appropriate facial expressions and/or gestures made by the user during the promotional conversation.

In one embodiment, the forthcomingness of the user when asked questions by the automated agent is assessed by accessing the time duration of verbal responses provided by the user when asked questions by the automated agent. In another embodiment, the forthcomingness is assessed by accessing the word count of verbal responses provided by the user when asked questions by the automated agent. In another embodiment, the forthcomingness is assessed by accessing the number of questions answered by the user when queried by the automated agent. In another embodiment, some or all of the time duration of verbal responses, word count of verbal responses, and number of verbal responses are used in combination to assess the forthcomingness of the user and thereby determine an award to be granted to the user. In another embodiment, only the time duration, word count, and/or number of verbal responses given by the user for context-appropriate appropriate responses are assessed.

In one embodiment, the text representation and/or alternate symbolic representation of the promotional information stored within the store of promotional information are embodied as one or more target information segments that are desired to be expressed. Accordingly, target information segments may include certain scripted information that is desired to be expressed and/or may include a certain number of words that is desired to be expressed. In many cases, a user may not remain engaged with the conversational advertisement for the full duration and not all of the target informational content will be expressed by the automated agent to the user. Accordingly, and in one embodiment, the amount/proportion of target information that was actually conveyed to the user can be assessed. For example, if the store of promotional information contained ten target information segments that the advertiser desired to cover and only six of the ten target information segments were conveyed prior to the user disengaging the conversational advertisement, a coverage value of 6/10 or 60% is computed and used alone or in combination with other factors to determine the user's participation level.

In one embodiment, different target information segments are weighted differently in importance by the advertiser. For such embodiments, the more heavily weighted target information segments count more than the less heavily weighted target information segments when computing the information coverage achieved by the user. Thus, if the user was exposed to six out of ten target information segments (i.e., covered target information segments) but those six target information segments were weighted more heavily than the target information segments that the user was not exposed to (i.e., non-covered target information segments), a coverage value of greater than 60% would be computed. There are many numerical methods by which such a weighted average coverage percentage can be computed. One method involves dividing the weighted number of not-covered target information segments by the weighted total of covered target information segments. In this way, the user's participation level can be assessed based on both the amount of information covered during the conversational advertisement as well as the importance or value of the information covered during the conversational advertisement.

In many cases, a sponsor/creator of an advertisement desires target information segments to be conveyed to a user multiple times during a promotional conversation. A user, however, may not remain engaged with the conversational advertisement for the full duration. As a result, the aforementioned target information segments will not be repeatedly presented to the user the number of times as desired. Accordingly, and in one embodiment, a user's participation level can be computed based on the number of times or the percentage of the target number of times that a particular target information segment was conveyed by the automated agent to the user. The number of times or percentage of the target number of times may then be used alone or in combination with other participation metrics to assess the participation level of the user. In one embodiment, the store of promotional information may further include a listing of one or more of the aforementioned target information segments that are desired by the advertiser to be presented to the user a target number of times during a promotional conversation.

In one embodiment, the amount/proportion of information expressed by the automated agent to the user during the promotional conversation is used, in whole or in part, to compute, increment, or adjust the participation level of the user. In another embodiment, the type and/or value and/or importance of the information content expressed by the automated agent to the user during the promotional conversation is used to compute, increment, or adjust the participation level for the user. In another embodiment, the number of times certain information is repeated during the promotional conversation is used, in whole or in part, to compute, increment, or adjust the participation level value for the user. In another embodiment, the time duration of the promotional conversation between the user and the automated agent is used, in whole or in part, to compute, increment, or adjust the participation level for the user. In another embodiment, the user's forthcomingness during the promotional conversation with the automated agent is used to compute, increment, or adjust the participation level for the user.

As mentioned above, the reward computation/disbursement circuitry is adapted to compute reward units based on the user's assessed participation level. In one embodiment, one or more participation level values and/or changes in one or more participation level values are used to compute reward units. Accordingly, a reward unit represents a value of a reward to be disbursed or an incremental change in the value of a reward to be disbursed.

In one embodiment, reward units intended to be disbursed to different entities (e.g., the user, the sponsor of the advertisement, the creator of the advertisement, etc.) may be differently computed. Moreover, different metrics may be used for each of the different computations of reward units. For example, reward units computed for the user reward the user for being exposed to the certain information conveyed during a promotional conversation. In such embodiments, reward units may be computed as a certain number of reward units based on the user's maintaining a promotional conversation for a certain duration during which he was exposed to information of a certain importance level. These reward units may then be disbursed to the user or the user's family (e.g., added to the user's reward account that is supported by the conversational advertising apparatus). The disbursed reward units may then be redeemed by the user (or the user's family) to access (e.g., view, hear, download, etc.) desired content such as television programming, movies, music, or other published content. In this way, the user (or the user's family) gains access to desirable content in exchange for being exposed to information through a means that allows the information to be experienced independently of the desirable content. The method and apparatus outlined above may find particular use with content-on-demand. Moreover, the disbursement of reward units based upon an assessment of the user's conversational activity allows the sponsor to provide viewing rights to content based upon the user's actual participation level, being a significant benefit to the sponsor over current advertising models. Further, the disbursement of reward units based upon the user's conversational activity allows a user to separate periods of advertising participation from periods of content viewing, creating a more convenient framework than traditional advertising modes that imparts constant interruptions to the content viewing thereby breaking up the natural flow.

In one embodiment, the conversational advertising apparatus is adapted to present the user with a running tally of reward units earned. In a further embodiment, the running tally is displayed as a numerical value in a corner of the screen upon which the automated agent is being displayed. In another embodiment, the running tally is displayed as a numerical value on another screen that is in electronic communication with the local computer 304 that is displaying the promotional conversation. In another embodiment, the running tally is displayed as a graphical chart or table. In another embodiment, the running tally is displayed as an audible vocalization. In this way, the user has direct feedback of how his participation is translating into reward units earned. If the tally is incrementing slowly, the user may chose to end the particular promotional conversation and enter a different one that may provide a faster yield. In this way, the creators of promotional conversations have an incentive to set up the rules for reward generation that are fair, but also competitive with other promotional conversations. Also, in one embodiment, a MAX YEILD value is presented to the user prior to engaging in the promotional conversation. The MAX YEILD is a numerical indication of the maximum award that a user can get by fully experiencing the promotional conversation. This MAX YIELD value is displayed in some embodiments, prior to the user agreeing to participate in the promotional conversation. Also, in one embodiment, a TYPICAL YEILD value is presented to the user prior to engaging in the promotional conversation. The TYPICAL YEILD is a numerical indication of the maximum award that a user can get by fully experiencing the promotional conversation. This TYPICAL YIELD value is displayed in some embodiments, prior to the user agreeing to participate in the promotional conversation. In one embodiment, an ESTIMATED TIME is also presented to the user prior to engaging in the promotional conversation. The ESTIMATED TIME is a duration that a typical user will spend interacting with the promotional conversation to either achieve a typical yield or a maximum yield. In one embodiment, two ESTIMATED TIME values are presented to the user, one for the typical yield and for a maximum yield. By having access to such yield values and time values, a user can assess whether he or she wants to take part in a given promotional conversation. Also, having such values accessible provides an inventive to the creators of conversational advertisements to make their rules for awarding participation-dependant rewards to be competitive with other creators of conversational advertisements.

In one embodiment, the participation assessment circuitry stores participation data indicating assessments of each user's participation level in promotional conversations on a central server (e.g., the same server from which the store of promotional information is accessed by the local computer 304). In another embodiment, the participation assessment circuitry additionally stores group participation data associated with a plurality of users, wherein the group participation data may be further processed to determine the effectiveness of the established conversational advertisement. For example, the group participation data may identify a mean user participation level of all users for whom user participation levels are assessed and stored. Conversational advertisements that elicit a larger mean user participation level can then be deemed as effective advertisements while conversational advertisements which elicit a lower mean user participation level may be deemed as less effective advertisements. In one embodiment, the group participation data may identify demographic-specific mean user participation levels. In such embodiments, the participation level of a particular user is stored on the central server along with certain data from the user's demographic profile. For example, a user's participation level for a particular advertisement is stored in a central server associated with that particular advertisement along with that user's gender, age, and income level. This data can then be processed along with similar data from a number of other users to determine the mean user participation level for users of a particular gender and/or age range and/or income level range. In this way, the effectiveness of a conversational advertisement can be assessed with respect to different demographic categories of users such as males or 18-25 year olds or middle class women with college educations. Any one or any combination of demographic factors mentioned previously with respect to a user's demographic profile may be stored along with a user's assessed participation level in the central server. The central server may be an internet accessible computer or computers or may be any other machine that can receive data from a plurality of users who interact with a particular conversational advertisement. In some embodiments, the central server runs software routines for producing a conversational advertisement effectiveness report for the producer and/or owner of a given advertisement. The conversational advertisement effectiveness report lists the mean, median, or other statistical measure of user participation level across a plurality of users who have interacted with a given conversational advertisement over a particular period of time. The report may include a plurality of different demographic analyses of the user participation data, providing numerous indications of how advertisement effectiveness varies with the demographic characteristics of users.

In one embodiment, a plurality of users can jointly engage in a promotional conversation with an automated agent. In one such embodiment, the plurality of users may jointly earn rewards based upon their combined conversational activity such that the rewards are evenly shared between the plurality of users. In another such embodiment, the plurality of users individually earn rewards based upon their individual conversational activity. In embodiments where each of the plurality of users individually earn rewards based upon their individual conversational activity, the conversational advertising apparatus may further include voice identity recognition circuitry adapted to identify which of the particular user or users is speaking at any given time. In this way, the conversational advertising apparatus can individually determine the conversational activity for each of the plurality of users based upon their identified voice. Voice identity recognition circuitry is known in the art. For example, U.S. Pat. Nos. 4,054,749 and 6,298,323, each of which are hereby incorporated by reference, both disclose methods and apparatus for voice identity recognition. Embodiments that enable a plurality of users to engage in a promotional conversation together are particularly valuable in many situations. For example, a husband and wife may be shopping for cars together and would find it most effective to jointly engage conversational advertisements about cars. Similarly, many situations involve multiple members of a family engaging advertisements together and so these methods are highly valuable for such situations. To support such situations, the embodiments disclosed herein may be further adapted to provide a family-based reward units and/or a family-based joint reward account such that any member of the family (or other defined group of users) can earn reward units that are credited to the family's joint reward account when conversational advertisements are engaged by any member or members of the family. Similarly, any member or members of the family (or other defined group of users) can redeem reward units to pay for media content, the spent reward units being decremented from the family's joint reward account. Such a model may be highly effective for family members who live in the same household (or other groups of people living in the same household) because such users will often desire to watch the same media content at the same time. Enabling a joint account for a plurality of users to jointly earn and spend reward units is therefore highly convenient.

In one embodiment, two users who have separate reward accounts can pool reward units in order to pay for a piece of media content that they desire to jointly watch. In this way, family members and/or other groups of users who choose to watch media content together can individually earn and redeem reward units through the inventive methods disclosed herein but can still jointly watch media content with a fair splitting of the reward unit expense.

Numerous embodiments disclosed herein enable a user to exit a promotional conversation at any time, earning reward units for their accrued participation. This allows a user to engage in a promotional conversation without feeling trapped for an indefinite amount of time. In one embodiment, a user may to exit a promotional conversation by pressing a key or other manual manipulandum (not shown) connected to the local computer 304 displaying the conversational advertisement. In another embodiment, a user may to exit a promotional conversation by reciting a pre-assigned exit phrase (e.g., “End Conversation”, “Terminate Conversation”, “Exit Conversation”, etc.) adapted to trigger the exit sequence within the conversational advertising apparatus. In such embodiments the speech recognition circuitry is adapted to identify the pre-assessed exit phrase as having been uttered by the user respond by initiating an exit sequence within the conversational advertising apparatus. In one embodiment, the exit sequence causes the automated agent to query the user (e.g., by saying “Are you sure you want to end the conversation?”) to ensure that he or she really wishes to exit. The user can then respond affirmatively or negatively. In some embodiments, the exit sequence also includes the display of the amount of accrued reward units and/or the percentage of total possible reward units earned by the user at that point in the promotional conversation. Such a display can be text or graphics. Such a display can be verbal. For example, in one embodiment the automated agent is configured to utter an exit sequence phrase such as “You have earned 235 reward units out of a total possible yield of 600 reward units. Are you sure you want to exit now?” The user can then respond affirmatively or negatively. In some embodiments, the user can suspend a conversational advertisement such that he or she can return to the conversation later and continue from the point where he or she left off.

Finally some embodiments, allow the user to subjectively rate a conversational advertisement at the point when he or she exits. Such rating data stored and used to configure future conversational advertisements to be well tailored to the preferences of the user. For example if a particular advertisement was rating very high by the user, similar advertisements will be more likely presented to the user in the future as compared to those conversational advertisements that were rated lower by the user. In one embodiment, the user is asked to rate the effectiveness of a particular conversational advertisement to convey useful information on as scale of 1 to 10. In one embodiment, the user is also asked to rate his or her personal enjoyment while engaging a particular conversational advertisement on a scale of 1 to 10.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of rewarding conversational activity of a user maintaining a promotional conversation with an automated agent, comprising:
causing an automated agent to be presented to a user engaging a local computer;
causing promotional information to be conveyed to the user in a promotional conversation via the automated agent;
causing the automated agent to prompt the user for information in the promotional conversation;
assessing the user's participation level in the promotional conversation;
computing reward units based on the user's assessed participation level; and
disbursing the computed reward units to a reward account associated with the user, wherein disbursed reward units are redeemable by the user for a reward.

2. The method of claim 1, wherein causing the automated agent to be presented the user comprises causing the automated agent to be audibly presented to the user.

3. The method of claim 1, wherein causing the automated agent to be presented the user comprises causing the automated agent to be visually presented to the user.

4. The method of claim 1, wherein causing promotional information to be conveyed to the user via the automated agent comprises causing at least one of a voice, an image, a video, and text to be conveyed to the user.

5. The method of claim 1, wherein causing promotional information to be conveyed to the user via the automated agent comprises:
discerning captured words spoken by the user engaging the local computer;
identifying promotional information stored within a pool of promotional information accessible to the local computer based on the discerned words; and
causing the identified promotional information to be conveyed to the user.

6. The method of claim 1, further comprising:
identifying a demographic profile of the user; and
causing promotional information to be conveyed to the user via the automated agent based on the demographic profile identified.

7. The method of claim 1, wherein assessing the user's participation level in the promotional conversation comprises assessing a verbal interaction of the user with the automated agent.

8. The method of claim 1, wherein assessing the user's participation level in the promotional conversation comprises assessing a non-verbal interaction of the user with the automated agent.

9. The method of claim 1, wherein assessing the user's participation level in the promotional conversation comprises assessing a time duration during which the user maintains the promotional conversation.

10. The method of claim 1, wherein assessing the user's participation level in the promotional conversation comprises assessing an interest level expressed by the user during the promotional conversation.

11. The method of claim 1, wherein assessing the user's participation level in the promotional conversation comprises assessing the user's forthcomingness in providing information after being prompted during the promotional conversation.

12. The method of claim 1, wherein assessing the user's participation level in the promotional conversation comprises assessing at least one of an amount and proportion of promotional information conveyed to the user via the automated agent during the promotional conversation.

13. The method of claim 1, wherein assessing the user's participation level in the promotional conversation comprises assessing a value of the promotional information conveyed to the user via the automated agent during the promotional conversation.

14. The method of claim 1, further comprising causing a tally of reward units earned by the user to be presented to the user during the promotional conversation.

15. The method of claim 1, further disbursing computed reward units to at least one of a sponsor of the promotional conversation and the creator of the promotional conversation.

16. The method of claim 1, wherein the reward comprises media content that is presentable to the user.

17. The method of claim 1, further comprising enabling the user to exit the promotional conversation.

18. The method of claim 17, wherein enabling the user to exit the promotional conversation comprises enabling the user to initiate an exit sequence.

19. An apparatus for rewarding conversational activity of a user maintaining a promotional conversation with an automated agent, comprising:
a local computer containing circuitry adapted to:
cause an automated agent to be presented to a user engaging the local computer;
cause promotional information to be conveyed to the user in a promotional conversation via the automated agent;
cause the automated agent to prompt the user for information in the promotional conversation;
assess the user's participation level in the promotional conversation;
compute reward units based on the user's assessed participation level; and
disburse the computed reward units to a reward account associated with the user, wherein disbursed reward units are redeemable by the user for a reward.

20. The apparatus of claim 19, wherein the local computer contains circuitry adapted to assess the user's participation level by determining whether or not the user provides one or more context-appropriate verbal utterances in response to one or more prompts from the automated agent.

21. The apparatus of claim 19, wherein the local computer contains circuitry adapted to assess the user's participation level by determining whether or not the user provides one or more context-appropriate facial expressions in response to one or more prompts from the automated agent.

22. The apparatus of claim 19, wherein the local computer contains circuitry adapted to assess the user's participation level by determining whether or not the user provides one or more context-appropriate gestures in response to one or more prompts from the automated agent.

23. The apparatus of claim 19, wherein the local computer contains circuitry adapted to assess the user's participation level by determining a number of words spoken by said user during the promotional conversation.

24. The apparatus of claim 19, wherein the local computer contains circuitry adapted to assess the user's participation level by determining a number of questions asked by said user during the promotional conversation.

25. The apparatus of claim 19, wherein the local computer contains circuitry adapted to assess the user's participation level by determining a time duration of the promotional conversation.

26. An apparatus for rewarding conversational activity of a user maintaining a promotional conversation with an automated agent, comprising:
means for causing an automated agent to be presented to a user engaging the local computer;
means for causing promotional information to be conveyed to the user in a promotional conversation via the automated agent;
means for causing the automated agent to prompt the user for information in the promotional conversation;
means for assessing the user's participation level in the promotional conversation;
means for providing a reward to the user based upon the user's assessed participation level.

27. The apparatus of claim 26, wherein the means for assessing the user's participation level comprises a means for capturing and analyzing one or more verbal utterances provided by the user in response to one or more verbal prompts provided by the automated agent.
